(19) United States
(12) Patent Application Publication
(10) Pub. No.: US 2004/0056065 A1
(43) Pub. Date: Mar. 25, 2004

(54) Multi-track nail insertion apparatus

(76) Inventor: Erik C. Wasko, Boynton Beach, FL (US)

Correspondence Address: ALLEN D. HERTZ, 12784 TULIPWOOD CIRCLE, BOCA RATON, FL, 33428, US

(21) Appl. No.: 10/254,623

(22) Filed: Sep. 25, 2002

(51) Int. Cl. B27F 7/00

(52) U.S. Cl. 227/109

(57) ABSTRACT

A multi-track nail insertion tool that contains two or more tracks for holding nails allows the user to use a single tool for inserting a variety of sizes of nails. The multiple tracks allowing the user to load a variety of sizes of nails during a single loading process. The user would then adjust the multi-track nail insertion tool to select the desired nail size. The multiple tracks or reservoirs can be selected by rotating the multiple tracks, sliding the multiple tracks, selecting one of multiple insertion mechanisms, and adjusting the position of the nail insertion applicator. The reservoirs can be designed whereby one reservoir can support one nail gauge size and a second reservoir can support a different nail gauge size. An alternate can include a design that is adjusted or with replaceable components to provide the ability to change nail gauge sizes. The multi-track nail insertion tool can include a reference to allow the user to indicate which length of nail has been placed within the nail reservoirs. The multi-track nail insertion tool can be enhanced by including commonly known features, such as safety switches, various loading means, etc.

### FIELD OF THE INVENTION

The present invention relates to a nail gun, more specifically a nail gun with the capability of containing multiple sizes of nails simultaneously and allowing the user to select and insertion any of the various inserted sizes of nails.

### BACKGROUND OF THE INVENTION

Nail and staple insertion tools, commonly referred to as “Nail guns” or “Staple guns” are known to have the capability of loading a variety of sizes of nails and/or staples within a single chamber. The current configurations are generally of a single chamber and a single insertion system, whereby the insertion system includes a mechanism with a single insertion pin, the pin and placement designed to apply a single insertion force to a single location.

The currently known nail and staple insertion tools are limited whereby the current technology allows for the loading a variety of sizes of at least one of nails and staples, but the technology is confined to the ability to insertion only a single size. This is further substantiated whereby all currently known nail and staple insertion tools comprise a single loading chamber which limits the user to the ability of only insertion a single object positioned respective to a single insertion force applicator.

What is desired is a nail insertion tool, which allows the user to load a variety of sizes of nails and the user to select and insertion a specific sized nail without having to change the size of the nails loaded within the apparatus. An apparatus providing a means for presenting multiple sizes of nails simultaneously to at least one insertion force applicator.

### SUMMARY OF THE INVENTION

One aspect of the present invention is a nail insertion tool comprising multiple nail feeding chambers.

A second aspect of the present invention is a nail insertion tool comprising a insertion selection mechanism.

A third aspect of the present invention is a nail insertion tool comprising a plurality of insertion force applicators.

A forth aspect of the present invention is a nail insertion tool comprising an insertion selection mechanism, whereby the insertion selection mechanism selects between a plurality of insertion force applicators.

A fifth aspect of the present invention is an insertion mechanism, the insertion mechanism comprising a primary insertion mechanism (such as a piston and cylinder), an insertion selection member, and a plurality of insertion mechanism force applicators.

A sixth aspect of the present invention further enhances the fifth aspect of the present invention wherein said insertion selection mechanism further comprising a sliding mechanism, the sliding mechanism selectively engages the insertion mechanism force applicator with one of the plurality of insertion mechanism force applicators.

A seventh aspect of the present invention further enhances the fifth aspect of the present invention wherein said insertion selection mechanism further comprising a rotating mechanism, the rotating mechanism selectively engages between the primary insertion force presentation member and one of the plurality of secondary insertion force applicators.

An eighth aspect of the present invention is a nail insertion tool comprising a plurality of insertion pneumatic chambers.

A ninth aspect of the present invention is a nail insertion tool comprising a pneumatic insertion selection mechanism, whereby the pneumatic insertion selection mechanism selects between each of a plurality of insertion pneumatic chambers.

A tenth aspect of the present invention is a nail insertion tool comprising a insertion mechanism, the insertion mechanism comprising a plurality of insertion pneumatic chambers, each with a respective insertion valve, a pneumatic insertion selection member, and a plurality of insertion force applicators, whereby each insertion pneumatic chamber is coupled to a insertion force applicator.

An eleventh aspect of the present invention further enhances the tenth aspect of said pneumatic insertion selection mechanism, the pneumatic insertion selection mechanism comprising a sliding mechanism, the sliding mechanism selectively engages between a insertion trigger and one of the plurality of insertion valves.

A twelfth aspect of the present invention further enhances the tenth aspect of said pneumatic insertion selection mechanism, the pneumatic insertion selection mechanism comprising a rotating mechanism, the rotating mechanism selectively engages between a insertion trigger and one of the plurality of insertion valves.

A thirteenth aspect of the present invention further enhances the tenth aspect of said pneumatic insertion selection mechanism, the enhancement comprising a plurality of selection members preferably positioned on the upper portion of the nail gun body whereby the user can depress the selection member with a thumb prior to actuating the insertion trigger.

A fourteenth aspect of the present invention further enhances the tenth aspect of said pneumatic insertion selection mechanism, the enhancement comprising a means of selecting the desired insertion chamber within a trigger mechanism.

A fifteenth aspect of the present invention further enhances the fourteenth aspect of the present invention, the enhancement furthers said pneumatic insertion selection mechanism, said pneumatic insertion selection mechanism further comprising a slide mechanism to position the insertion trigger mechanism respective to the desired insertion chamber.

A sixteenth aspect of the present invention further enhances the fourteenth aspect of the present invention, the enhancement furthers said pneumatic insertion selection mechanism comprising a plurality of actuation members positioned within a rotating pneumatic selection member positioned between the trigger mechanism and the pneumatic chambers, whereby the rotation of the rotating pneumatic selection member directly or indirectly engages the trigger mechanism and a single, desired insertion chamber actuation valve.

A seventeenth aspect of the present invention, the multi-track nail apparatus comprising a plurality of nail feeding chambers and a means of adjusting the position of the plurality of nail feeding chambers respective to a single insertion mechanism.

An eighteenth aspect of the present invention further enhances the seventeenth aspect of the present invention, the enhancement furthers the means of adjusting the position of the plurality of nail feeding chambers respective to a single insertion mechanism, whereby the means of adjusting the position is controlled by rotating the multiple tracks about a pivot point positioned in a manner whereby the pivoting motion positions the desired nail within the desired nail feeding chamber proximate the insertion force actuator.

A nineteenth aspect of the present invention comprising a plurality of nail chambers, the embodiment comprising at least one nail chamber providing a means to load the at least nail chamber from the side of the apparatus.

A twentieth aspect of the present invention comprises two nail chambers arranged in parallel, each providing a means to load the nail chamber from the side of the apparatus.

A twenty-first aspect of the present invention enhances the twentieth aspect of the present invention, the enhancement furthers the two nail chambers arranged in parallel; the two nail chambers arranged in parallel comprising a first nail chamber having access on a first side of the nail gun, a second nail chamber having access on a second side of the nail gun, whereby the first side is opposing the second side of the nail gun.

A twenty-second aspect of the present invention comprising a plurality of nail chambers, the embodiment comprising at least two nail feeding chambers, providing a means to load at least one of the at least two nail feeding chambers from at least one of the front, rear, top, and bottom of the apparatus.

A twenty-third aspect of the present invention comprising a plurality of nail feeding chambers, the embodiment comprising at least one nail feeding chamber providing a means to load the at least nail feeding chamber from the side of the apparatus and a second means for loading at least a second nail feeding chamber from at least one of the front, rear, top, and bottom of the apparatus.

A twenty-forth aspect of the present invention, the apparatus comprising a plurality of nail feeding chambers, the embodiment comprising a first nail feeding chamber having access for loading nails on a first side of the nail gun, a second nail feeding chamber having access for loading nails on a second side of the nail gun, and at least a third nail feeding chamber having access for loading nails from at least one of the front, rear, top, and bottom of the nail gun.

A twenty-fifth aspect of the present invention is the inclusion of a plurality of parallel nail guide slots, whereby each nail guide slot is positioned respective to standard nail lengths and head dimensions.

A twenty-sixth aspect of the present invention comprises a safety switch for actuation of the insertion mechanism.

A twenty-seventh aspect of the present invention comprises a safety switch inclusive within the insertion selection mechanism.

A twenty-eighth aspect of the present invention is a tapered insertion end.

A twenty-ninth aspect of the present invention is a tapered insertion end, wherein the tapered insertion end is moveably coupled to the mechanical insertion selection mechanism, whereby the motion of the mechanical insertion selection mechanism positions the tapered insertion end proximate the respective nail feeding chamber.

A thirtieth aspect of the present invention is the inclusion of a nail retaining member respective to each nail feeding chamber.

A thirty-first aspect of the present invention is the inclusion a detent or other mechanism respective to the insertion selection mechanism to provide mechanical feedback to the user respective to the selected insertion chamber.

A thirty-second aspect of the present invention is the inclusion of a means to identify the size of the nails placed within each of the respective nail feeding chambers.

A thirty-third aspect of the present invention is the inclusion of a means to inform the user that the quantity of nails within the nail loading chamber has reached a predetermined number. One means of accomplishing this is a different sound when the last nail is inserted. A second means of accomplishing this would be the inclusion of a safety feature, whereby the safety feature disables the insertion system when the quantity is at or below a predetermined number.

A thirty-forth aspect of the present invention is the inclusion of a means to adjust the insertion force that is applied to the nail.

A thirty-fifth aspect of the present invention is the ability to design the plurality of nail loading chambers, such that each nail loading chamber is designed for a specific nail gauge whereby the respective nail gauge of at least one the plurality of nail loading chambers differs from the respective nail gauge of the other nail loading chambers of the single nail insertion tool.

A thirty-sixth aspect of the present invention is the inclusion of a pneumatic exhaust vent for return of the piston to a ready state.

### BRIEF DESCRIPTION OF THE DRAWINGS

FIG. 1 is an isometric view of a first embodiment using multiple pneumatic insertion mechanisms for implementation of the present invention.

FIG. 2 is an isometric view of a second embodiment using a single pneumatic insertion mechanism in conjunction with a plurality of nail feeding chambers that rotate for insertion of a nail from a desired nail feeding chamber.

FIG. 3 is a front view of the second embodiment of FIG. 2 to better illustrate the second embodiment.

FIG. 4 is a front view of a third embodiment using a single pneumatic insertion mechanism in conjunction with a plurality of nail feeding chambers that slidably adjust respective to the position of the single pneumatic insertion mechanism for insertion of a desired nail from a selected nail feeding chamber of the plurality of nail feeding chambers.

FIG. 5 is an isometric view of a first variance of the first embodiment illustrating a variation on the selecting mechanism respective to the multiple pneumatic insertion mechanisms for implementation of the present invention.

FIG. 6 illustrates a second variance of the first embodiment illustrating a variation on the selecting mechanism respective to the multiple pneumatic insertion mechanisms for implementation of the present invention.

FIG. 7 is an isometric view of a forth embodiment using single pneumatic insertion mechanism in conjunction with a pneumatic insertion force applicator that is slideably engaged to the single pneumatic insertion mechanism providing the ability to select a desired nail from a selected nail feeding chamber of the plurality of nail feeding chambers.

### DETAILED DESCRIPTION OF THE INVENTION

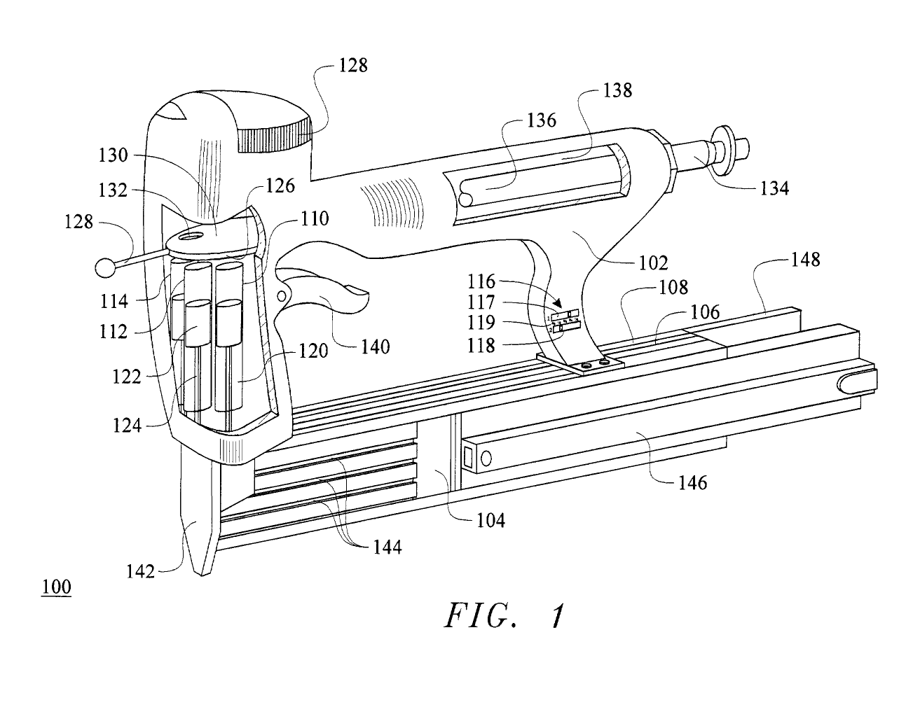

FIG. 1 is an isometric view of a first embodiment of the present invention. The illustration details the first embodiment of a pneumatic, multiple track, nail insertion apparatus 100, the pneumatic, multiple track, nail insertion apparatus 100 comprising, a body 102, and at least two nail feeding chambers, illustrated as a first, external nail feeding chamber 104, at least one center nail feeding chamber 106, and a second external nail feeding chamber 108. It can be recognized that the illustration is for presentation purposes and the combinations and positions of the at least two nail feeding chambers 104, 106, 108 should not change the spirit or intent of the present invention. The pneumatic, multiple track, nail insertion apparatus 100 would be designed whereby the user can selectively insert any of the nails (not shown) from any of the at least two nail feeding chambers 104, 106, 108. The first embodiment accomplishes the ability to insert nails from any of the at least two nail feeding chambers 104, 106, 108 by providing multiple pneumatic insertion mechanisms 110, 112, 114. The first embodiment provides at least two pneumatic insertion mechanisms 110, 112, 114 respective to each of the least two nail feeding chambers 104, 106, 108, wherein the illustration presents three pairs of pneumatic insertion mechanisms 110, 112, 114 and nail feeding chambers 104, 106, 108. Each pneumatic insertion mechanism 110, 112, 114 comprising a pneumatic cylinder 120, a piston 122, and an insertion force applicator 124. The user can select the desired nail to be inserted by adjusting the position of a pneumatic insertion mechanism airflow controller 126 using a pneumatic insertion mechanism selector 128. In this embodiment, the user would rotate the pneumatic insertion mechanism airflow controller 126 using the pneumatic insertion mechanism selector 128. The pneumatic insertion mechanism airflow controller 126 comprising the pneumatic insertion mechanism selector 128, a rotatable plate 130, any required pneumatic seals (not shown), and an airflow orifice 132. Two versions of the insertion mechanism selector 128 are illustrated: the first is a fixed member, directly coupled to the pneumatic insertion mechanism airflow controller 126, the second is a geared mechanism whereby the controller is positioned towards the upper, forward section the body 102 and operates the pneumatic insertion mechanism airflow controller 126 using gears, levers, and the like (not shown). The airflow would be delivered by coupling the pneumatic, multiple track, nail insertion apparatus 100 to a compressed air source (not shown) by coupling a pneumatic sourcing hose (not shown) to a pneumatic coupler 134. The airflow continues towards the at least two pneumatic insertion mechanisms 110, 112, 114 via an airflow path, the airflow path provided by either an airline 136 or using a hollowed airflow path 138 within the body 102. The selected pneumatic insertion mechanism (110, 112, or 114) would be actuated by a trigger 140. The user would depress the trigger 140, the trigger 140 would allow the airflow to pass through the airflow orifice 132 and apply pressure within the cylinder 120 resulting in a insertion force applied to the respective piston 122. The respective piston 122 would be forced downwards transferring the insertion force to the nail (not shown) via the insertion force applicator 124. The insertion force applicator 124 is designed such to shear a single nail from a series of nails that are linearly coupled together. The nails are held within nail guide slots 144, each nail guide slot 144 is positioned for a specific gauge and length nail. The nail guide slots 144 could extend from the rear of the nail feeding chambers 104, 106, 108 to a position one nail head short of the pneumatic insertion mechanisms 110, 112, 114. The insertion force applicator 124 would apply an insertion force (not shown) to the nail positioned in line with the pneumatic insertion mechanisms 110, 112, 114, and the remaining nails would be supported by nail guide slots 144 allowing the insertion force applicator 124 to shear the single nail from the series of nails that are linearly coupled together. The series of nails that are linearly coupled together would be maintained towards the insertion force applicator 124 by a retaining force (not shown) applied by a first external nail retaining member 146 respective to the first, external nail feeding chamber 104, and a second external nail retaining member 148 respective to the second external nail feeding chamber 108. The pneumatic, multiple track, nail insertion apparatus 100 can comprise of additional retaining force applicators respective to each of the respective nail feeding chambers such as for the center nail feeding chamber 106. The nails would be contained within the nail feeding chambers 104, 106, 108 by a nail feeding chamber end-cap 142.

The present invention provides the user the ability to load multiple sizes of nails into the at least two nail feeding chambers 104, 106, and 108. It would be beneficial to the user for the apparatus to include a mechanism which provides the user a means to indicate the size of the nails within each of the at least two nail feeding chambers 104, 106, and 108. FIG. 1 includes one example of a nail size indicator 116, the illustrated example of the nail size indicator 116 comprising a nail size indicator slot 117, a nail size indicator tab 118 and a nail size indicator reference 119. The user would slide the nail size indicator tab 118 within the nail size indicator slot 117 to a position adjacent the respective nail size identified by the nail size indicator reference 119. It can be recognized that the illustration is one means of providing the user the ability a means to indicate the size of the nails within each of the at least two nail feeding chambers 104, 106, and 108, and that there are numerous other means to identify the size of the nails within each of the at least two nail feeding chambers 104, 106, and 108. It can be recognized that a designer can provide any of numerous design solutions to provide a means for referencing the size of the nails. Such alternative mechanisms can include alternative slide designs, a dial design, a pin design, a viewing window, and the like. The embodiment of the nail size indicator 116 should not limit the spirit and intent of the present invention. It can be recognized that the pneumatic insertion mechanism selector 128 illustrated as the pneumatic insertion mechanism airflow controller 126 can alternatively be a series of valves (not shown), one valve respective to each of the plurality of pneumatic insertion mechanisms 110, 112, 114. The valve would be selectively, mechanically coupled to the trigger 140, whereby the user would adjust a selection mechanism, the selection mechanism would selectively engage the desired valve to the trigger 140. One means of accomplishing this would be a rotating disk. A second means of accomplishing this would be a sliding rail.

It can be recognized that the incorporation of multiple nail feeding chambers 104, 106, 108 provides the ability to design each of the nail feeding chambers 104, 106, 108 to provide a means for feeding nails of differing gauges within the same pneumatic, multiple track, nail insertion apparatus 100. One means of accomplishing this feature would be by designing each of the multiple nail feeding chambers 104, 106, 108 for distinct nail gauges. A second means of accomplishing this feature would be the ability to change at least a portion of at least one of the multiple nail feeding chambers 104, 106, 108 in order to provide the ability to support varying gauges of nails.

It can be recognized that although the illustration and specification specifically describes the incorporation of a pneumatic insertion mechanism, alternative insertion mechanisms, such as electric insertion mechanism can be utilized while maintaining the spirit and intent of the present invention.

Additional features that are commonly known and can be included are: a safety mechanism, an adjustable nail depth setting mechanism, toploading systems, and any other commercially known features.

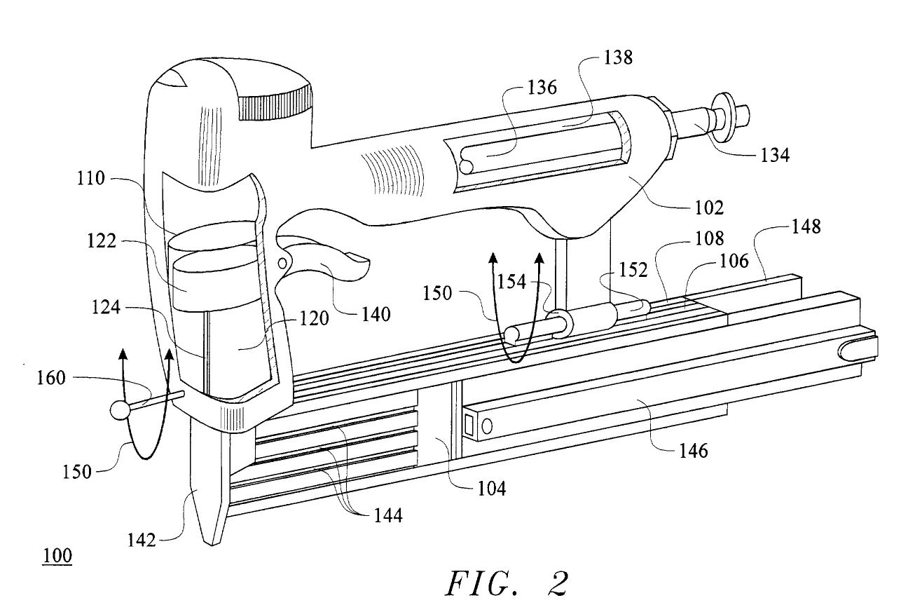

FIG. 2 is an isometric view of a second embodiment of the present invention; the illustration details the second embodiment of a pneumatic, multiple track, nail insertion apparatus 100. The second embodiment comprises the same basic features of the first embodiment, a body 102, and at least two nail feeding chambers, illustrated as a first, external nail feeding chamber 104, at least one center nail feeding chamber 106, and a second external nail feeding chamber 108, a trigger 140, a nail feeding chamber end-cap 142. It can be recognized that the illustration is for presentation purposes and the combinations and positions of the at least two nail feeding chambers 104, 106, 108 should not change the spirit or intent of the present invention. The pneumatic, multiple track, nail insertion apparatus 100 would be designed whereby the user can selectively insert any of the nails (not shown) from any of the at least two nail feeding chambers 104, 106, 108. The second embodiment accomplishes the ability to insert nails from any of the at least two nail feeding chambers 104, 106, 108 by providing the ability to rotate 150 the at least two nail feeding chambers 104, 106, 108 to align the desired nail feeding chamber 104, 106, or 108 to a single pneumatic insertion mechanism 110. The at least two nail feeding chambers 104, 106, 108 would rotate 150 using any means for rotating two coupled objects, with the illustrated embodiment utilizing a pivot shaft 152 moveably coupled to a collar 154. The at least two nail feeding chambers 104, 106, 108 are registered to the single pneumatic insertion mechanism 110 using a nail feeding chamber release and registration mechanism 160.

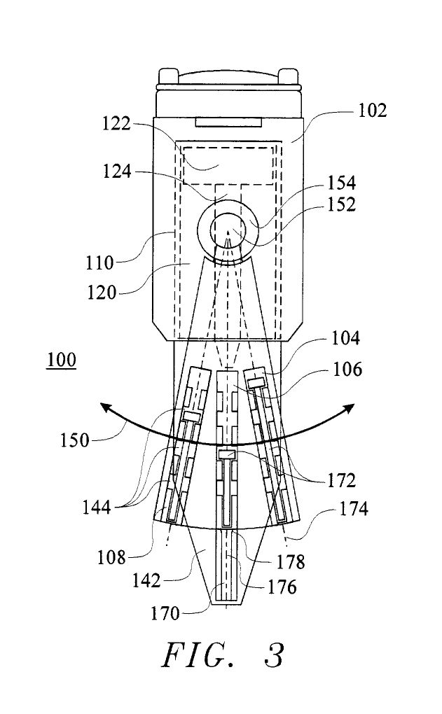

FIG. 3 illustrates a front view of the second embodiment shown in FIG. 2. The front view illustrates the common elements of the pneumatic, multiple track, nail insertion apparatus 100, including a body 102, at least two nail feeding chambers, illustrated as a first, external nail feeding chamber 104, at least one center nail feeding chamber 106, and a second external nail feeding chamber 108, and a nail feeding chamber end-cap 142. The nail feeding chamber end cap 142 can include a nail insertion conduit 170 used for directing nails 172 into the object during the insertion process. The front view better illustrates the positioning of the at least two nail feeding chambers 104, 106, 108 providing the ability to rotate 150 the at least two nail feeding chambers 104, 106, 108. The at least two nail feeding chambers 104, 106, 108 would be positioned whereby the nail feeding chamber centerline 174 would pass through the center of the pivot shaft 152, and the center of the pivot shaft 152 is aligned with the nail insertion conduit centerline 176. The nail insertion conduit 170 can include a nail guide tapered lead-in 178 to assist with the transfer of the nail 172 from the selected nail feeding chamber 104, 106, or 108 to the nail insertion conduit 170 during the insertion process. The nail insertion conduit 170 provides a distance between the at least two nail feeding chambers 104, 106, 108, allowing the pneumatic, multiple track, nail insertion apparatus 100 to insert nails 172 into a small area.

The Inventor further teaches the position of the pivot shaft 152 affects the layout of the at least two nail feeding chambers 104, 106, 108, including the overall width of the apparatus. The greater the distance between the pivot shaft 152 and the least two nail feeding chambers 104, 106, 108, the smaller the angle between the least two nail feeding chambers 104, 106, 108.

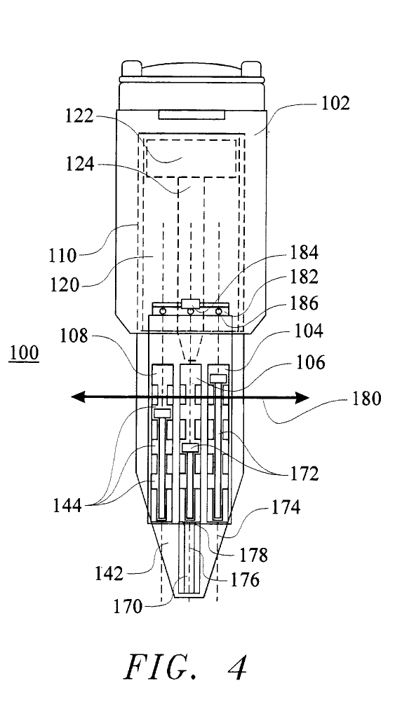

FIG. 4 illustrates a third embodiment of the present invention; the illustration details the third embodiment of a pneumatic, multiple track, nail insertion apparatus 100. The third embodiment comprising the same basic features of the first and second embodiments, a body 102, and at least two nail feeding chambers, illustrated as a first, external nail feeding chamber 104, at least one center nail feeding chamber 106, and a second external nail feeding chamber 108, a trigger 140, a nail feeding chamber end-cap 142. It can be recognized that the illustration is for presentation purposes and the combinations and positions of the at least two nail feeding chambers 104, 106, 108 should not change the spirit or intent of the present invention. The pneumatic, multiple track, nail insertion apparatus 100 would be designed whereby the user can selectively insert any of the nails 172 from any of the at least two nail feeding chambers 104, 106, 108. The third embodiment accomplishes the ability to insert nails from any of the at least two nail feeding chambers 104, 106, 108 by providing the ability to slideably adjust 180 the at least two nail feeding chambers 104, 106, 108 to align the desired nail feeding chamber 104, 106, or 108 to a single pneumatic insertion mechanism 110. The at least two nail feeding chambers 104, 106, 108 would slideably adjust 180 using any means for slideably adjusting two coupled objects, with the illustrated embodiment utilizing a slideable shaft 182 moveably coupled to a slideable collar 184. The at least two nail feeding chambers 104, 106, 108 are registered to the single pneumatic insertion mechanism 110 using a nail feeding chamber release and registration mechanism (not shown). The illustration includes a series of registration holes 186, whereby the registration mechanism would comprise a registration pin (not shown) that would locate and maintain the registration of the desired nail feeding chamber 104, 106, or 108 to the nail insertion conduit 170.

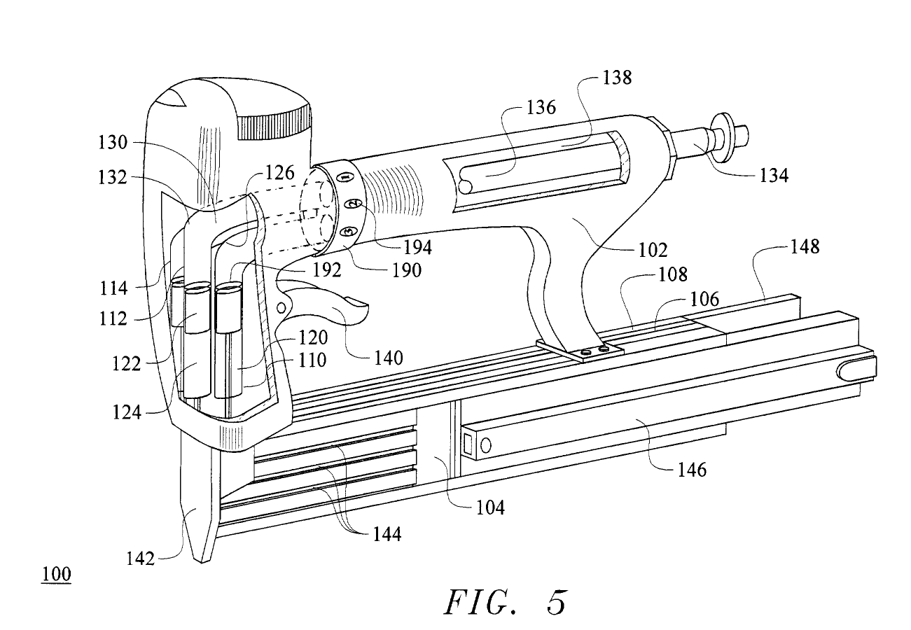

FIG. 5 illustrates a variance on the first embodiment, utilizing a rotatable collar 190 as a means for selecting one of the multiple pneumatic insertion mechanisms 110, 112, 114. Each of the multiple pneumatic insertion mechanisms 110, 112, 114 would be configured in a manner whereby the rotatable collar 190 will pneumatically select the pneumatic conduit to one of the multiple pneumatic insertion mechanisms 110, 112, 114. The user would rotate the rotatable collar 190. The rotatable collar 190 would comprise a rotating plate positioned between the sourced airflow 136, 138 and the conduits respective to the multiple pneumatic insertion mechanisms 110, 112, 114, the rotating plate being similar to the pneumatic insertion mechanism airflow controller 126 of FIG. 1. Each cylinder 120 would include a piston indexing member 192, the piston indexing member 192 would provide a means for maintaining a maximum position of the piston 122 in the retracted position (as shown). The rotatable collar 190 can include a nail feeding mechanism reference 194 as a means to advise the user of the source (which of the nail feeding chambers 104, 106, 108) of the nail to be inserted.

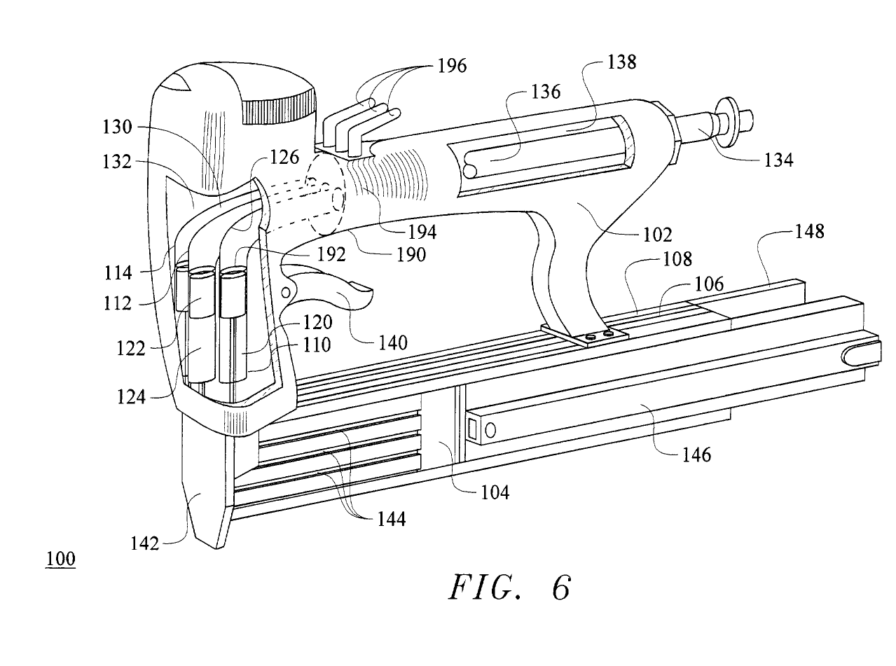

FIG. 6 illustrates a second variance on the first embodiment, utilizing a series of selection pushbuttons 196 as a means for selecting one or more of the multiple pneumatic insertion mechanisms 110, 112, 114. Each of the multiple pneumatic insertion mechanisms 110, 112, 114 would be configured in a manner whereby the selection pushbuttons 196 will pneumatically select at least one of the pneumatic conduits to one of the multiple pneumatic insertion mechanisms 110, 112, 114. The user would depress at least one of the selection pushbuttons 196. The selection pushbuttons 196 would comprise an actuating mechanism, pneumatic valve and the like (not shown) positioned between the sourced airflow 136, 138 and the conduits respective to the multiple pneumatic insertion mechanisms 110, 112, 114, the selection pushbuttons 196 providing a means to control the airflow between the sourced airflow 136, 138 and the conduits respective to the multiple pneumatic insertion mechanisms 110, 112, 114. Each cylinder 120 would include a piston indexing member 192, the piston indexing member 192 would provide a means for maintaining a maximum position of the piston 122 in the retracted position (as shown). It can be recognized that there are numerous means of using selection pushbuttons 196 to select one or more airflow sources. The present invention should not be limited by the means of selecting airflow passages to one or more of the conduits respective to the multiple pneumatic insertion mechanisms 110, 112, 114. The present invention has described a means for selecting one or more of the conduits respective to the multiple pneumatic insertion mechanisms 110, 112, 114 using a rotating mechanism about the top of the body, the front of the body, and pushbuttons. One advantage of the second variance of the first embodiment would be the ability to insert multiple nails during a single insertion process.

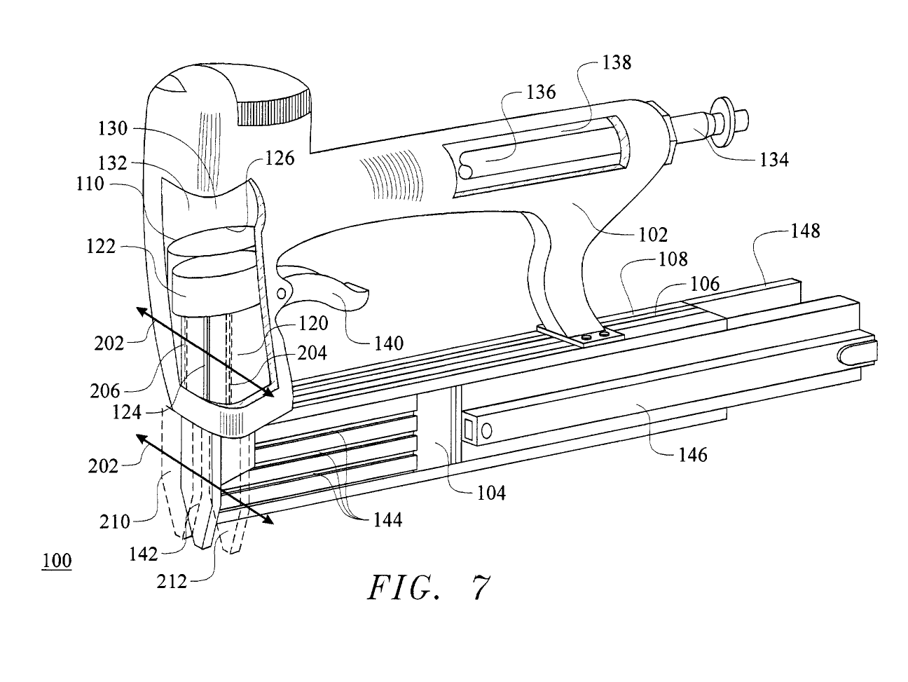

FIG. 7 illustrates an isometric view of a forth embodiment using single pneumatic insertion mechanism in conjunction with a pneumatic insertion force applicator that is slideably engaged to the single pneumatic insertion mechanism providing the ability to select a desired nail from a selected nail feeding chamber of the plurality of nail feeding chambers. The illustration details the forth embodiment of a pneumatic, multiple track, nail insertion apparatus 100. The forth embodiment comprising the same basic features of the first and second embodiments, a body 102, and at least two nail feeding chambers, illustrated as a first, external nail feeding chamber 104, at least one center nail feeding chamber 106, and a second external nail feeding chamber 108, a trigger 140, a nail feeding chamber end-cap 142. It can be recognized that the illustration is for presentation purposes and the combinations and positions of the at least two nail feeding chambers 104, 106, 108 should not change the spirit or intent of the present invention. The pneumatic, multiple track, nail insertion apparatus 100 would be designed whereby the user can selectively insert any of the nails (not shown in this illustration) from any of the at least two nail feeding chambers 104, 106, 108. The forth embodiment accomplishes the ability to insert nails from any of the at least two nail feeding chambers 104, 106, 108 by providing the ability to slideably adjust 202 the insertion force applicator 124 from a centered position respective to the centered nail feeding chambers 106, to a first insertion force applicator outer position 204 respective to the first, external nail feeding chamber 104, and slideably adjust 202 the insertion force applicator 124 to a second insertion force applicator outer position 206 respective to the second external nail feeding chamber 108. It would be preferable where the nail feeding chamber end-cap 142 would also slideably adjust 202 in concert with the insertion force applicator 124. The nail feeding chamber end-cap 142 would slideably adjust 202 from the centered position as shown to a first nail end cap outer position 210 respective to the first, external nail feeding chamber 104 and slideably adjust 202 the feeding chamber end-cap 142 to a second feeding chamber end-cap outer position 206 respective to the second external nail feeding chamber 108. This would maintain a smaller cross sectional area providing the ability to insert nails into small areas. The insertion force applicator 124 would apply an insertion force to the desired nail by a force transferred by a single pneumatic insertion mechanism 110, the single pneumatic insertion mechanism 110 comprising a single piston 122 positioned within a single cylinder 120. It can be recognized that there are many mechanisms to control the slideably adjusting 202 of the insertion force applicator 124 and nail feeding chamber end-cap 142.

What is claimed is:

1. A nail insertion apparatus, the nail insertion apparatus comprising:
a body,
a nail insertion mechanism,
at least two nail feeding chambers,
and a mechanism to selectively insert a nail from any of the at least two nail feeding chambers.

2. The nail insertion apparatus of claim 1, wherein the mechanism to selectively insert a nail from any of the at least two nail feeding chambers comprises a rotating member for rotating the at least two nail feeding chambers, wherein the rotational motion registers a desired nail feeding chamber to the nail insertion mechanism.

3. The nail insertion apparatus of claim 1, wherein the mechanism to selectively insert a nail from any of the at least two nail feeding chambers comprises a sliding member for sliding the at least two nail feeding chambers, wherein the sliding motion registers a desired nail feeding chamber to the nail insertion mechanism.

4. The nail insertion apparatus of claim 1, the nail insertion mechanism further comprising an insertion force applicator, and
wherein the insertion force applicator is capable of adjusting its position respective to the at least two nail feeding chambers in order to selectively insert a nail from any of the at least two nail feeding chambers.

5. The nail insertion apparatus of claim 4, the nail insertion apparatus further comprising a nail feeding chamber end-cap, whereby the nail feeding chamber end-cap is capable of adjusting its position to register to a adjusted position of the insertion force applicator.

6. The nail insertion apparatus of claim 1, at least one of the at least two nail feeding chambers further comprising a member that can be at least one of adjusted and replaced to provide the ability to feed and insert two or more gauges of nails.

7. The nail insertion apparatus of claim 1, the nail insertion apparatus further comprising a nail size indicator.

8. A nail insertion apparatus, the nail insertion apparatus comprising:
a body,
at least two nail insertion mechanisms,
at least two nail feeding chambers,
and a mechanism to selectively apply an insertion force to a nail positioned within one of the at least two nail feeding chambers by selecting at least one of the nail insertion mechanisms.

9. The nail insertion apparatus of claim 8, the mechanism to selectively apply an insertion force to a nail positioned within one of the at least two nail feeding chambers by selecting at least one of the nail insertion mechanisms comprising a mechanism to control an airflow between an airflow source and each of the at least two nail insertion mechanisms.

10. The nail insertion apparatus of claim 9, wherein the mechanism to control the airflow between an airflow source and each of the at least two nail insertion mechanisms is at least partially operated by a trigger.

11. The nail insertion apparatus of claim 9, wherein the mechanism to control the airflow between an airflow source and each of the at least two nail insertion mechanisms is operated by a mechanism coupled to the body.

12. The nail insertion apparatus of claim 8, at least one of the at least two nail feeding chambers further comprising a member that can be at least one of adjusted and replaced to provide the ability to feed and insert two or more gauges of nails.

13. The nail insertion apparatus of claim 8, the nail insertion apparatus further comprising a nail size indicator.

14. A nail insertion apparatus, the nail insertion apparatus comprising:
a body,
at least one pneumatically operated nail insertion mechanism,
at least two nail feeding chambers,
and a mechanism to selectively insert a nail from any of the at least two nail feeding chambers.

15. The nail insertion apparatus of claim 14, wherein the mechanism to selectively insert a nail from any of the at least two nail feeding chambers comprises a rotating member for rotating the at least two nail feeding chambers, wherein the rotational motion registers a desired nail feeding chamber to the at least one pneumatically operated nail insertion mechanism.

16. The nail insertion apparatus of claim 14, wherein the mechanism to selectively insert a nail from any of the at least two nail feeding chambers comprises a sliding member for sliding the at least two nail feeding chambers, wherein the sliding motion registers a desired nail feeding chamber to the at least one pneumatically operated nail insertion mechanism.

17. The nail insertion apparatus of claim 14, the nail insertion apparatus comprising one pneumatically operated nail insertion mechanism,
the pneumatically operated nail insertion mechanism further comprising an insertion force applicator, and
wherein the insertion force applicator is capable of adjusting its position respective to the at least two nail feeding chambers in order to selectively insert a nail from any of the at least two nail feeding chambers.

18. The nail insertion apparatus of claim 17, the nail insertion apparatus further comprising a nail feeding chamber end-cap, whereby the nail feeding chamber end-cap is capable of adjusting its position to register to the adjusted insertion force applicator.

19. The nail insertion apparatus of claim 14, at least one of the at least two nail feeding chambers further comprising a member that can be at least one of adjusted and replaced to provide the ability to feed and insert two or more gauges of nails.

20. The nail insertion apparatus of claim 14, the nail insertion apparatus further comprising a nail size indicator.
